(19) United States
(12) Patent Application Publication
(10) Pub. No.: US 2006/0006609 A1
(43) Pub. Date: Jan. 12, 2006

(54) Insulating exhaust manifold gasket with integrated load limiters

(76) Inventors: Gregory J. Sandford, Chicago, IL (US); Paul M. Fatora, Woodridge, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/158,664

(22) Filed: Jun. 21, 2005

Related U.S. Application Data
(60) Provisional application No. 60/586,612, filed on Jul. 9, 2004.

(51) Int. Cl. F02F 11/00

(52) U.S. Cl. 277/595

(57) ABSTRACT

An exhaust manifold gasket having a gasket body including at least two metal plates defining a first surface and a second surface is described herein. The body has a plurality of service openings defining at least one exhaust hole and a plurality of bolt holes. The second surface includes a foldover around a perimeter of the body. A thermally resistant layer may be located between the first surface and the second surface and extends beyond a sealing region of the gasket. A load limiting layer that works to prevent excess compression at the bolt holes is disposed proximate a metal plate.

### CROSS-REFERENCE To RELATED APPLICATIONS

This application claims the benefit of U.S. Provisional Application Ser. No. 60/586,612 filed Jul. 9, 2004, which is hereby incorporated by reference in its entirety.

### TECHNICAL FIELD

The embodiments of the invention described herein are generally directed to insulating exhaust manifold gaskets.

### BACKGROUND

An engine and a gasket installed therein for an automobile include exhaust ports, water holes, oil holes and bolt holes. Since high pressure and temperature are developed within the exhaust ports when the engine is actuated, bolts for securing the engine parts together with the gasket are generally arranged around the exhaust ports. Tightening of the bolts creates a pressure around the exhaust ports, thereby forming a seal therearound.

Traditional gaskets have used embossments, or metal sealing beads to seal around exhaust ports. These known gasket designs permit thermal conduction from the manifold to the cylinder head. Accordingly, some type of insulating material is required to prevent thermal damage from occurring to the cylinder head or other nearby engine components. However, insulating material as a seal is typically unsatisfactory as it tends to have a low density and therefore a high material compression, particularly around the bolts where the entire load was being applied. Because of the high degree of material compression, manifold flanges would deform so as to bend around the more rigid sealing area of the gasket, thereby causing an undesirable leak path. Accordingly, there is a need for an insulating heat shield gasket that prevents undesirable leakage.

Standard foldover style gaskets incorporate load limiting/load balancing features both around the port being sealed and gasket perimeter by perimeter foldovers. Integrating a heat shield with geometry extending beyond the required gasket prevents the use of a perimeter foldover to control load balancing (perimeter compression) and load limiting at the bolts. Therefore, it would be desirable to integrate a separate the load limiting layer into the gasket. The perimeter foldover is therefore not used for load balance purposes, but to contain the filler material.

### SUMMARY

The embodiments described herein provide an exhaust manifold gasket having a gasket body including at least two metal plates defining a first layer and a second layer. The body has a plurality of service openings defining at least one exhaust hole and a plurality of bolt holes. Either the first or the second layer includes a metal foldover around a perimeter of the body. A thermally resistant layer may be located between the first layer and the second layer including a plurality of service openings corresponding to the body and can extend beyond the required sealing area of the gasket to provide heat shielding to other engine components. In one embodiment, a load limiting layer is located on the upper surface of the first layer of the gasket. In another embodiment, the load limiting layer is located between the first layer and the thermally resistant layer, where the load limiting layer works to prevent excess compression at the bolt holes and provide proper exhaust port sealing of the outer exhaust manifold surface perimeter.

### BRIEF DESCRIPTION OF THE DRAWINGS

The features and inventive aspects of the present invention will become more apparent upon reading the following detailed description, claims, and drawings, of which the following is a brief description:

FIG. 1 is a plan view of a first embodiment of an insulating exhaust manifold gasket showing a load limiting layer on a surface of the gasket;

FIG. 2 is a cross-sectional view of the insulating exhaust manifold gasket taken along lines 2-2 of FIG. 1;

FIG. 3 is a cross-sectional view of the insulating exhaust manifold gasket taken along lines 3-3 of FIG. 1;

FIG. 4 is a cross-sectional view of the insulating exhaust manifold gasket taken along lines 4-4 of FIG. 1;

FIG. 5 is a cross-sectional view of the insulating exhaust manifold gasket taken along lines 5-5 of FIG. 6;

FIG. 6 is a plan view of a second embodiment of an insulating exhaust manifold gasket showing the load limiting layer between the upper and lower surfaces of the gasket;

FIG. 7 is a cross-sectional view of the insulating exhaust manifold gasket taken along lines 7-7 of FIG. 6;

FIG. 8 is a cross-sectional view of the insulating exhaust manifold gasket taken along lines 8-8 of FIG. 6; and

FIG. 9 is a top plan view of an individual load limiter according to an embodiment of an insulating exhaust manifold gasket.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

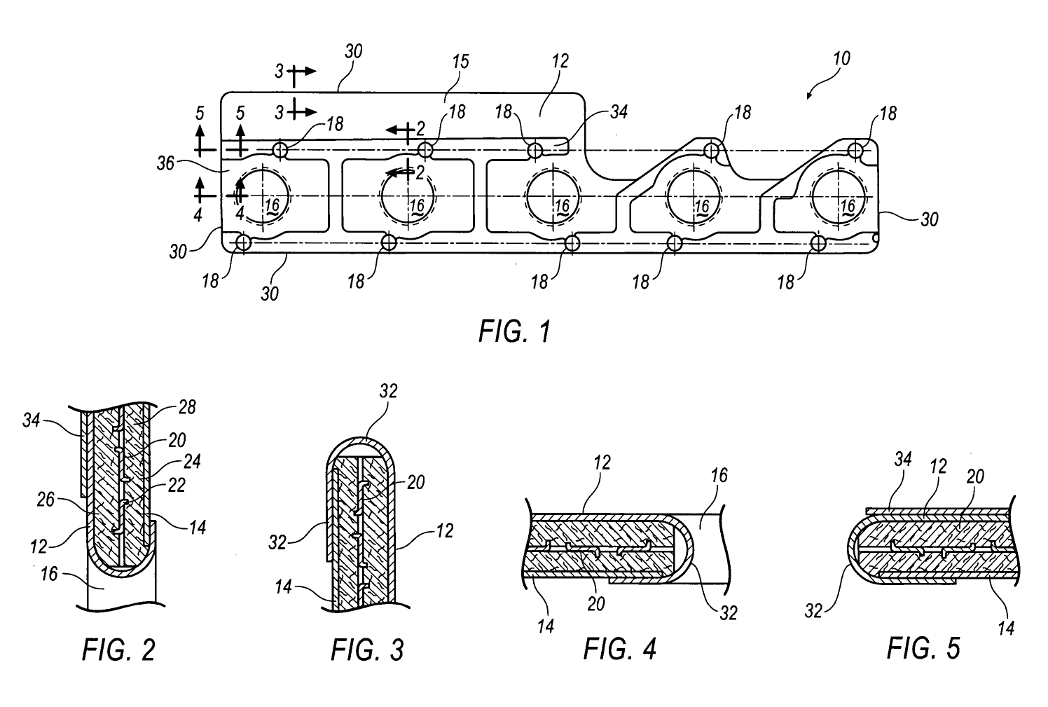

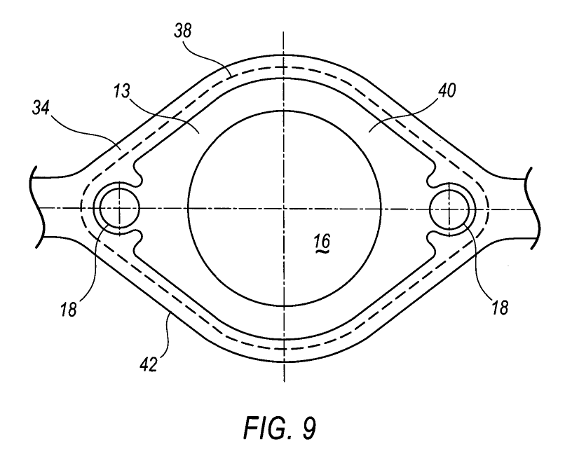

Referring now to FIGS. 1-5, and 9, a gasket 10 having first metal layer 12 and second metal layer 14 is disclosed. The metal layers 12, 14 are constructed of any steel or alloy. In one embodiment, the gasket 10 is formed from a stainless steel or a nickel alloy. The gasket 10 is held between mating joint surfaces of an exhaust manifold 13 as shown in FIG. 9 and a cylinder head (not shown), to seal the opposing surfaces to each other. The exhaust manifold, cylinder head, and gasket 10 are fixed to each other with bolts to maintain the air tightness thereof and prevent the leakage of an exhaust gas.

In accordance with another embodiment of the invention, rather than provide individual gaskets at each port, the gasket 10 is a one piece gasket and the large gasket body 15 extends between the ports. The body 15 defines a plurality of apertures or openings, including conventional exhaust port openings 16 and bolt holes 18. The gasket 10 may also include other holes (not shown) Various sealing mechanisms such as protective coatings, beads, and the like may be provided as well.

As shown in FIG. 2, the body 15 may include a thermally resistant layer 20 disposed between the first and second metal layers 12, 14 having a plurality of openings corresponding to the plurality of openings in the first and second metal layers 12, 14.

The materials for the thermally resistant layer 20 incorporated in the metal gasket 10 will now be described. The materials constituting the thermally resistant layer 20 include but are not limited to high temperature insulation, inorganic materials, Dana Xtreme Plus®, and, for example, a mica material, which has the following characteristics. A mica material is a natural incombustible material, and has a resistance to heat of not lower than 1000 degrees Celsius, so that it can sufficiently withstand the temperature of an exhaust gas in the exhaust port opening 16 of, for example, 800 degrees-900 degrees Celsius. Moreover, a mica material has a high corrosion resistance, a high chemical resistance, and excellent heat insulating characteristics. Any material for the thermally resistant layer may incorporate a perforated or solid steel core for rigidity. Any material for the thermally resistant layer 20 may be characterized by a low density. Insulating composite materials are used in an incompletely densified form, causing compression under load. Layer 20 may exhibit these characteristics for proper sealing.

As shown in FIG. 3, in accordance with an embodiment, the first metal layer 12 is longer than the second metal layer 14 at a perimeter 30 of the metal gasket 10 such that a foldover 32 of the first metal layer 12 may be folded over the thermally resistant layer 20 and onto the second metal layer 14. The foldover 32 around the exhaust port opening 16 of the metal gasket 10 works to concentrate the load onto the sealing area. In another embodiment, the second metal layer 14 may be longer than the first metal layer 12 around the perimeter 30 of the metal gasket 10 such that the foldover 32 of the second metal layer 14 may be folded over the thermally resistant layer 20 and onto an upper surface 36 of the first metal layer 12. In yet another embodiment, the first metal layer 12 may be longer than the second metal layer 14 at predetermined edges; while the second metal layer 14 may be longer than the first metal layer 12 at other predetermined edges (not shown).

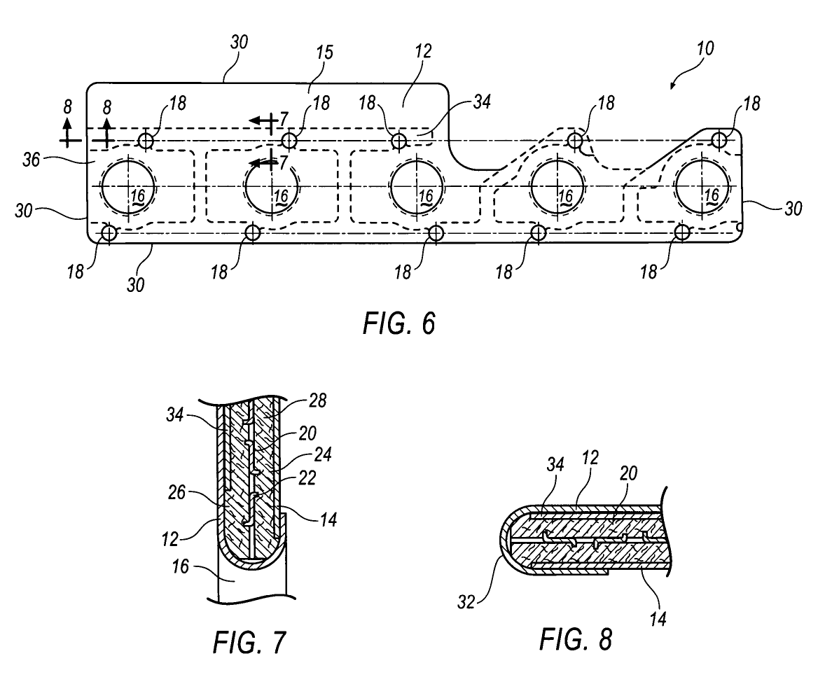

A load limiting layer 34 is disposed proximate the upper surface 36 of the first metal layer 12. In one embodiment as best shown in FIGS. 1 and 5, the load limiting layer 34 is assembled to the first metal layer 12 of the metal gasket 10 at the upper first surface 36 and may be attached using rivets, welding, foldovers or any other suitable attachment method. In another embodiment as shown in FIG. 6, the load limiting layer 34 (shown in dotted lines) is disposed between the first metal layer 12 and the thermally resistant layer 20. The load limiting layer 34 is proximate the bolt holes 18 of the metal gasket 10 and around a flange perimeter 38 as shown in FIG. 9. The dotted line in FIG. 9 represents the face surface of the mating exhaust manifold flange. The load limiting perimeter 42 represents how the load limiting layer 34 may support both the bolt hole 18 areas and exhaust manifold flange perimeter 38. Preferably, the load limiting layer 34 is one large piece for easier assembly in production rather than individual load limiters at each exhaust manifold flange 13. The load limiting layer 34 is used to act as a load limiter and prevent excess material compression at the bolt holes 18 as well as a load balancer to properly distribute bolt load around the exhaust port (not shown) and the flange perimeter 38. However, individual load limiters may be utilized as the load limiting layer 34 for purposes of this disclosure. The load limiting layer 34 provides a stiffer area around the bolt holes 18 and further reduces relaxation of the thermally resistant layer 20. Moreover, the load limiting layer 34 provides less material deflection that also aids in the elimination of relaxation of the thermally resistant layer 20.

The load limiting layer 34, metal layers 12, 14, and insulating layer 20 may include various thicknesses to best balance the bolt load between the exhaust port and manifold flange perimeter 38.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely the following claims.

What is claimed is:

1. A gasket comprising:
a gasket body including at least two metal plates defining an upper layer and a lower layer, said body including a plurality of service openings defining at least one exhaust hole and a plurality of bolt holes, said lower layer including a metal foldover around at least a portion of a perimeter of the said body;
a thermally resistant layer disposed between said upper layer and said lower;
a load limiting layer limiting excess compression at said bolt holes and a flange perimeter disposed proximate said body.

2. The gasket of claim 1, wherein said metal foldover is formed by one of said metal plates that forms said lower layer being folded around said thermally resistant layer and on top said upper layer defined by the other metal plate.

3. The gasket of claim 1, wherein a periphery of said exhaust hole formed by said upper layer includes a foldover that extends downwardly such that said periphery of said exhaust hole of said upper layer extends downwardly toward said lower layer to receive said metal plate being folded over such that said foldover is generally flush with said upper layer of said body.

4. The gasket of claim 1, wherein said thermally resistant layer has a low density and high material compression.

5. The gasket of claim 1, wherein said thermally resistant layer includes a mica material.

6. The gasket of claim 5, wherein said mica material has a chemical resistance and heat insulating characteristics.

7. The gasket of claim 1, wherein said thermally resistant layer being able to withstand temperatures exceeding 800 degrees Celsius.

8. The gasket of claim 1, wherein said load limiting layer is disposed on an upper surface of said upper layer.

9. The gasket of claim 1, wherein said load limiting layer is disposed between said upper layer and said thermally resistant layer.

10. The gasket of claim 1, wherein said load limiting layer is disposed between said thermally resistant layer and said lower layer.

11. The gasket of claim 1, wherein said load limiting layer is disposed on a lower surface of said lower layer.

12. The gasket of claim 1, wherein said load limiting layer is an individual load limiter.

13. The gasket of claim 1, wherein said load limiting layer provides a stiffer area around only said bolt holes.

14. The gasket of claim 1, wherein said load limiting layer provides a stiffer area around only said bolt holes and said flange perimeter.

15. The gasket of claim 1, wherein gasket body extends beyond a sealing surface shielding engine components from heat.

16. An exhaust manifold gasket comprising:
a gasket body including at least two metal plates defining an upper layer and a lower layer, said body including a plurality of service openings defining at least one exhaust hole and a plurality of bolt holes, said lower layer including a metal foldover around a perimeter of the said body;
a foldover formed around a perimeter of said body;
a thermally resistant layer including a mica material disposed between said upper layer and said lower layer having a plurality of service openings corresponding to said body;
a load limiting layer providing a stiffer area and limiting excess compression at said bolt holes disposed proximate said upper layer.

17. The exhaust manifold gasket of claim 16, wherein said thermally resistant layer being able to withstand temperatures exceeding 800 degrees Celsius.

18. The exhaust manifold gasket of claim 16, wherein said load limiting layer provides a stiffer area around only said bolt holes.

19. The exhaust manifold gasket of claim 16, wherein said load limiting layer provides a stiffer area around only said bolt holes and a flange perimeter.

20. The exhaust manifold gasket of claim 16, wherein said load limiting layer is disposed on an upper surface of said upper layer.

21. The exhaust manifold gasket of claim 20, wherein said load limiting layer is integrated with said upper surface.

22. The exhaust manifold gasket of claim 16, wherein said load limiting layer is disposed between said upper layer and said thermally resistant layer.

23. The exhaust manifold gasket of claim 16, wherein said load limiting layer is disposed between said thermally resistant layer and said lower layer.

24. The exhaust manifold gasket of claim 16, wherein said load limiting layer is disposed on a lower surface of said lower layer.

25. The exhaust manifold gasket of claim 16, wherein said gasket body extends beyond a sealing surface shielding an engine component from heat generated by the exhaust manifold.
